(19) United States
(12) Patent Application Publication
(10) Pub. No.: US 2026/0132862 A1
(43) Pub. Date: May 14, 2026

(54) ACTUATOR FOR A VALVE

(71) Applicant: ELTORQUE AS, Trondheim (NO)

(72) Inventor: Jon Eirik BRENNVALL, Trondheim (NO)

(21) Appl. No.: 19/109,743

(22) PCT Filed: Sep. 4, 2023
(86) PCT No.: PCT/NO2023/060043

§ 371 Date: Mar. 7, 2025

(30) Foreign Application Priority Data
Sep. 7, 2022 (NO) 20220963

(51) Int. Cl. F16K 31/04

(52) U.S. Cl. CPC F16K 31/047

(57) ABSTRACT

Described herein is an actuator for a valve, comprising: a main shaft, comprising an opening extending along an axial centreline of the main shaft for receiving a valve stem, a first planetary gear system including a plurality of planetary gears, a first sun gear and a first ring gear wherein the planetary gear system is configured to rotate the main shaft about its axial centreline, and a motor for rotating the first planetary gear system, wherein the axial centreline of the main shaft and a central axis of the sun gear of the planetary gear system are coincident.

### FIELD OF THE INVENTION

The present invention relates to an actuator for a valve, and in particular to an actuator with an opening in the centre for receiving the valve stem of a gate valve, globe valve or a similar object operated by a stem.

### BACKGROUND OF THE INVENTION

Valves are used for controlling fluid flow in pipes. They are usually operated manually, often by a handle, hand wheel or tap. Examples are the taps for turning on and off water in showers and kitchen sinks.

There is, however, an increasing demand for actuators which make it possible to operate valves from a remote location. This is useful e.g. when the captain wants to trim the ballast water in a ship, and he doesn't want to send a crew member down into the engine room to open and close valves. Hydraulic, pneumatic, and electric actuators are used for this purpose. For economic and environmental reasons, electric actuators are taking market shares from hydraulic and pneumatic actuators.

An actuator typically consists of a motor and a gear system. In order to mount an actuator on a valve, the hand wheel on the valve is removed and the output shaft of the actuator is attached to the valve shaft. The valve shaft is referred to as a valve spindle (butterfly and ball valves) or valve stem (globe and gate valves). The actuator is controlled by microcontroller which receives instructions through a signal cable and then runs the motor to an open, closed or intermediate position based on the received instructions. Following operation, the controller reports back to the main system: operation complete or an error.

Valves come in many types and sizes. Some valves, like the butterfly valve and ball valve, are opened and closed by rotating the valve spindle attached to the moving part of the valve a quarter of a turn. Other valves, like the globe valve and gate valve have a stem that moves the moving parts of the valve up and down.

Both globe valves and gate valves usually have a stem where part of the stem is a threaded rod. The major difference between globe valves and gate valves, relevant for design of actuators for these valves, are:
The stem of the globe valve usually rotates with the hand wheel and moves up and down because the stem is screwed up and down through a nut which is part of the globe valve housing.
The stem of the gate valve usually doesn't rotate. The hand wheel is attached to a nut and thrust bearing and can therefore screw the stem up and down.

It is relatively easy to construct an electric actuator that can operate butterfly valves and ball valves, because the spindle is not moving up and down. An example of an actuator made for this purpose is the Eltorque QT250 actuator. This type is not suitable for a globe- or gate-valve because the stem cannot move up and down.

### DISCLOSURE OF THE STATE OF ART

AUMA Riester GmbH & Co. KG makes actuators that can operate gate valves. The actuators feature a gear wheel, instead of the hand wheel on manual actuators, which is driven by a worm wheel attached to the main shaft on the electrical actuator. The motor and the gearing of this actuator type is placed perpendicular to the stem.

In the AUMA actuator a stem nut is built into the actuator, and this part is rotated by the gear system. To operate a gate valve, the stem nut will be threaded and thereby translate the threaded valve stem upon its own rotation. The design results in a valve actuator that is not particularly compact.

US2013140476A1 discloses a rotary valve adapter assembly comprising an adapter plate configured to attach to a rotary valve body.

NO20200052A1 discloses a diverter valve drive mechanism that minimizes the overall volume of the diverter valve drive mechanism and maintains a large output torque.

US2011275477A1 discloses a planetary gear speed reducer including a gear bracket having a center hole and first, second and third locating portions arranged in parallel along the center hole.

US2007191177A1 discloses an automatic speed reducing ratio-switching apparatus comprising an input side carrier, an output side carrier, and an intermediate carrier.

U.S. Pat. No. 11,118,658B1 discloses an epicyclic gear system and method of a flow control actuator for providing selectable torque and speed ranges.

CN114233916A discloses a marine intelligent miniaturized electric actuating mechanism which comprises a motor, an output shaft and a planetary gear unit.

### OBJECTS OF THE PRESENT INVENTION

The object of the present invention is to provide an actuator for valves with stems. The main problem the invention aims to solve is how to make a compact actuator for a globe, gate or other stemmed valve. The advantage that the invention has over the prior art is its compactness.

### SUMMARY OF THE INVENTION

According to a first aspect of the present invention, there is provided an actuator for a valve, comprising: a main shaft comprising an opening extending along an axial centreline of the main shaft for receiving a valve stem, a first planetary gear system including a plurality of planetary gears, a first sun gear and a first ring gear, wherein the planetary gear system is configured to rotate the main shaft about its axial centreline, and a motor for rotating the first planetary gear system, wherein the axial centreline of the main shaft and the axis of the sun gear of the planetary gear system are coincident.

The term actuator for a valve, as used herein, refers to a device that can be mounted on a valve and can open or close the valve when it receives a signal to do so.

Reference to the first planetary gear system being configured to rotate the main shaft about its axial centreline is to the fact that the gear system is arranged to be coupled to the main shaft to cause the main shaft to rotate upon rotation or actuation of the planetary gear system. The coupling between the main shaft and the first planetary gear system need not necessarily be a direct coupling, and there may be one or more additional gear systems or other mechanisms arranged to couple the first planetary gear system to the main shaft.

In embodiments, the first sun and/or the first ring gear are arranged within the actuator so as to surround the main shaft and its opening, so that the valve stem is able to translate up and down along the axis of rotation of the first sun and/or the first ring gear during use and such that the shaft extends through the central opening of the first sun and/or ring gear. To allow the first sun gear to rotate about the main shaft, a bearing can be provided between the two. The first ring gear can be manufactured as a part of an actuator housing or it can be manufactured as a separate part which is mounted to be fixed inside said housing.

In embodiments, the actuator comprises a hollow valve nut coupled to the main shaft and comprising a through-hole having a centreline coincident with the axial centreline of the main shaft and through which the valve stem extends in use, wherein an internal surface of the through-hole is shaped to interact with the valve stem causing its translation along the axial centreline of the shaft upon rotation of the main shaft. The valve nut may be coupled to the main shaft to rotate with the main shaft.

In embodiments, the valve nut is configured to be removably connected to the main shaft. This way the actuator can be easily adapted to work with different types/sizes of valve. In embodiments, the valve nut and the main shaft are formed as one integral piece. The valve nut and shaft may be machined from the same piece of material, or molded as one piece, for example. The removable connection may be by way of one or more screws, for example, which can be unscrewed to replace the valve nut.

In embodiments, the motor for rotating the first planetary gear system is an electric motor.

In embodiments, the actuator comprises a rotor frame configured to be rotatable about the main shaft axial centreline and coupled to the main shaft via the first planetary gear system. In embodiments, the rotor frame is hollow and surrounds the main shaft. The main shaft therefore extends through the center of the rotor frame. This contributed to the small footprint of the actuator and its compact design.

In embodiments, the actuator comprises a locking mechanism including: a locking element transitionable between a locked position in which the locking element presses against the main shaft or against a lock ring that is fixed on the main shaft to prevent rotation of the main shaft and an unlocked position in which the main shaft can rotate relative to the locking element. In the unlocked position, the locking element does not press against the main shaft or lock ring and movement of the main shaft is not prevented. A novel feature of this embodiment is that the locking mechanism locks against the main shaft and not the housing of the actuator. This, again, helps to provide a particularly compact configuration for the overall mechanism.

In embodiments, the locking mechanism comprises at least one unlock-pin coupled to the rotor frame to transition the locking element from the locked to the unlocked position when the rotor frame is rotating in either direction around the main shaft axial centreline. The use of an unlock pin coupled to the rotor in this way means that turning of the shaft by way the rotor frame (as intended) is not prevented, where turning of the shaft by other means is. Unwanted actuation of the valve is therefore prevented.

In embodiments, the actuator comprises a second planetary gear system including a second plurality of planetary gears, a second sun gear and a second ring gear where the second planetary gear system is arranged to couple the first planetary gear system to the main shaft to rotate the main shaft about the axial centreline. The second planetary gear system may have the same structure as the first planetary gear system and may also be positioned to surround the shaft. The second planetary gear system is usually positioned above the first planetary gear system (further from the valve nut). In embodiments, one or more planetary gear systems similar to the second planetary gear system can be added on top of the second planetary gear system if desired. The number of planetary gear systems will depend on the specific design requirement as each planetary gear system will have a gear ratio and the system as a whole requires a certain total combined gear ratio, where the ratio of the separate systems multiply to form the total combined gear ratio. The addition of one or more additional planetary gear systems therefore increases flexibility of the actuator in terms of the achievable gear ratio.

In embodiments, the actuator comprises a first split annulus gear system including a bottom annulus sun gear, a plurality of bottom annulus planetary gears, a plurality of top annulus planetary gears, an annulus gear carrier and a top annulus sun gear, where the top annulus sun gear is arranged to rotate with main shaft. In embodiments, the first annulus gear system is configured to reverse the direction of rotation of the main shaft. This may be achieved by the top annulus sun gear having more teeth than the bottom annulus sun gear. In embodiments, therefore, the number of teeth on the top annulus sun gear is greater than the number of teeth on the bottom annulus sun gear. The advantage of including this split annulus gear system is that the gear ratio is potentially higher than that of the planetary gear systems, this may reduce the need for more planetary gear systems. Further if the annulus gear system is also configured to reverse the direction of rotation, the emergency operation wheel will have the same direction of rotation as the valve stem or nut, providing intuitive manual operation of the valve.

In embodiments, the hollow valve nut comprises internal threads allowing a threaded valve stem to be translated freely upwards along the centreline of main shaft upon rotation of main shaft. This configuration is suitable for gate valves or other valves where it is not desirable to have the stem rotate upon translation in the axial direction of the main shaft. Internal threads refer to threads located on the surface of the valve nut through-hole, which is the surface facing inwards towards the central axis.

In embodiments, the through-hole of the valve nut has a non-circular cross-section allowing a valve stem with similar cross-section to be translated freely upwards along the centreline of the main shaft upon rotation of the main shaft. This configuration is suitable for globe valves or other valves where it is allowable to have the stem rotate upon translation in the axial direction of the main shaft. Further the shape of the valve nut hole cross-section may have any non-circular shape, such as square, triangular, elliptical, rectangular, pentagonal, hexagonal or other polygonal shapes.

In embodiments, the rotor frame is the frame of the rotor of the electrical motor, and is configured to rotate about the axial centreline of the main shaft. The motor, including the rotor frame, is configured to turn the main shaft about its axial centreline. The rotor may comprise magnets, a squirrel cage or other configurations allowing magnetic interaction with a stator. The stator may surround the rotor frame. In embodiments, the motor is configured to turn the main shaft by transferring torque through a bottom emergency shaft and through the rotor frame to cause the main shaft to rotate. In this configuration the motor is mounted outside of the actuator housing and hence it can be an “off the shelf” electrical, hydraulic or pneumatic motor.

In embodiments, the actuator comprises an encoder comprising an encoder gearwheel mounted on the main shaft and configured to count a number of turns of the main shaft. The encoder gearwheel may rotate an encoder shaft, possibly via a set of encoder gears, so that the encoder shaft makes one rotation while the main shaft makes an integer number of rotations (generally two or more, and preferably between 15 and 40, most preferably 30). Counting a number of rotations of the main shaft allows the position of the valve to be monitored. The relative number of turns can obviously be adjusted as desired.

### DESCRIPTION OF THE FIGURES

Embodiments of the present invention will now be described, by way of example only, with reference to the following figures, wherein:

FIG. 1 shows a cross-section of an entire actuator, and isometric view from above and below;

FIG. 2 shows a first assembly step of installing the bottom of the actuator and a first planetary gear system;

FIG. 3 shows a second assembly step of installing a second planetary gear system;

FIG. 4 shows a third assembly step of installing a split annulus gear system;

FIG. 5 shows a forth assembly step of installing a self-lock mechanism;

FIG. 6 shows a fifth assembly step of installing a rotor and a stator of an electric motor for powering the actuator;

FIG. 7 shows the sixth assembly step of installing an emergency handle and encoder gearing. In the figure the plate these parts are typically mounted on is hidden, since it would otherwise hide most of the parts;

FIG. 8 shows the same as FIG. 7, but without any hidden parts;

FIG. 9 shows the main shaft;

FIG. 10 shows a first sun gear for a first planetary gear system;

FIG. 11 shows a carrier for the planetary gears in a multistage planetary gear system;

FIG. 12 shows a cross-section through the top planetary gears of the multistage planetary gear system;

FIG. 13 shows a cross-section through a self-lock mechanism as indicated on FIG. 1;

FIG. 14 shows the rotor in the motor, and

FIG. 15 shows the emergency mechanism separated into two parts.

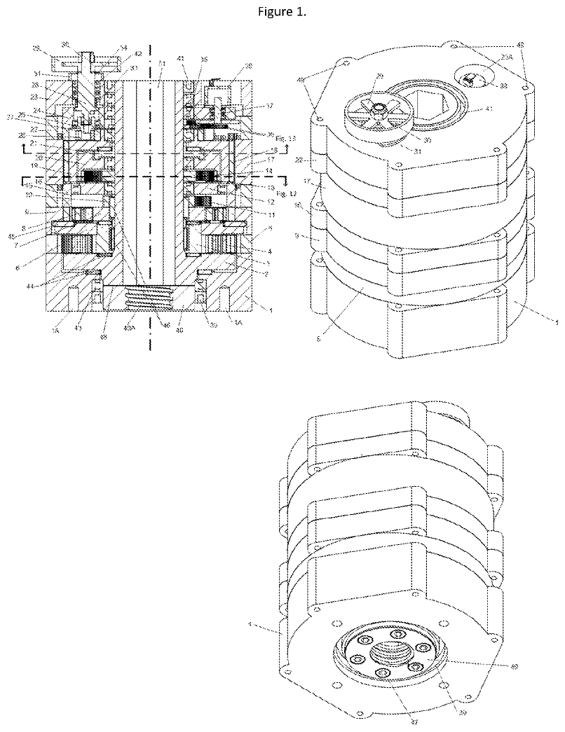

FIGS. 1 to 8 contain a cross-sectional view and at least one isometric view of the same assembly step. The remaining figures show parts that are important, or to some extent hidden in FIGS. 1 to 8.

### DESCRIPTION OF PREFERRED EMBODIMENTS OF THE INVENTION

The bottom of FIG. 1 shows a valve nut (40) suitable for actuation of a gate valve. The valve nut (40) is the nut which moves the stem of a gate valve up and down, and it must therefore be machined so that it fits the threads of the stem. It can be fixed to the main shaft (2) with bolts (47), so that the valve nut is easy to replace. If the actuator is to operate a globe valve then the threads (40A) in the valve nut (40) are replaced with a hole, the hole having a non-circular cross-section. The hole may have the same dimensions as the opening (51) extending axially through the main shaft (2). The cross-section of the hole may be of any non-circular shape, such as square, triangular, elliptical, rectangular, pentagonal, hexagonal. Including a shape with three or more corners is preferable since it can help to prevent slipping. A particularly advantageous shape for the cross-section of the valve nut opening is hexagonal. If the actuator is only intended to operate a globe valve, the cross-section of the central opening of the valve nut (40) and the cross-section of the valve stem should preferably have the same shape and suitable fit. If the actuator is only intended to operate gate valves the opening (51) inside the main shaft (2) can be of the same size and shape as the central opening of the valve nut (40), or it can be replaced by a round opening (51) which is much easier to machine. FIG. 1 shows a hexagon opening (51) in the main shaft (2) which allows the actuator to operate both globe and gate valves with only minor adjustments, as the opening (51) is big enough to accommodate a stem with threads in the case of operation of a gate valve and the same size as the valve nut hole in case of operation of a globe valve. The main shaft bottom seal (39) prevents water and dirt from entering the actuator. The valve nut (40) and main shaft (2) rotate inside the actuator bottom (1). There can be holes with threads (1A) in the actuator bottom (1) to mount the actuator on the valve. Bearings (43, 44) make sure the main shaft rotates smoothly. Any suitable coupling means can be used to couple the valve nut to the stem. It is also possible to construct the valve nut (40) and the main shaft (2) as one part. The advantage of doing so is that this results in an actuator with fewer parts and that the bottom seal (39) can then have same diameter as the top seal (41). The disadvantage is that the actuator will only fit on one type of valve, since both stem diameter, stem thread dimension and valve type must be correct.

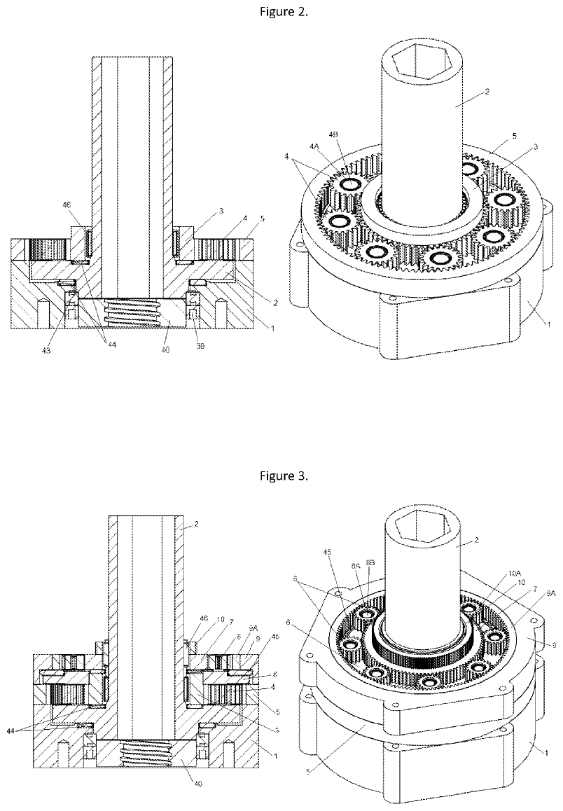

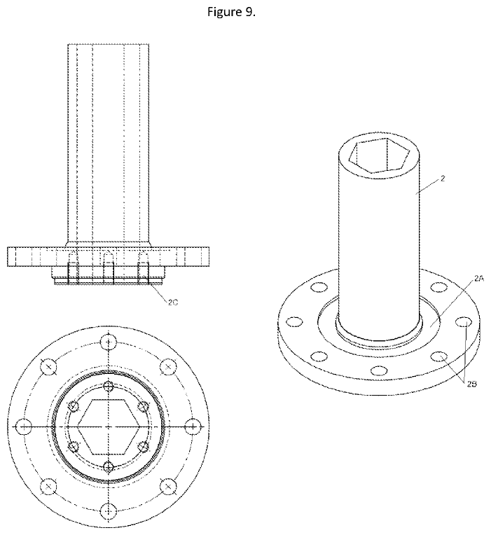

FIG. 2 shows the first assembly step. First ring gear (5) is placed on top of actuator bottom (1). First ring gear (5) and actuator bottom (1) can be manufactured as one part, but they are here shown as 2 parts, which is easier in terms of manufacturing. Inside the ring gear (5) are the first planetary gears (4) with bearings (4A) and shafts (4B). The shafts are pressed with a press pass into the holes (2B) in the main shaft (2). These holes (2B) are only visible in FIG. 9. The same goes for the bearing paths (2A). In the centre is the first sun gear (3, 6). The first sun gear is made up of two parts (3, 6) that are joined together with a press pass. They could have been manufactured as one part. A radial needle bearing (46) and an axial needle bearing (44) ensures that the first sun gear (3, 6) rotates smoothly around the main shaft (2). Modulo for the first planetary gear system is 1.5 in presented figures. The modulo is not fixed and can be changed to a value suitable for design parameters according to a specific design.

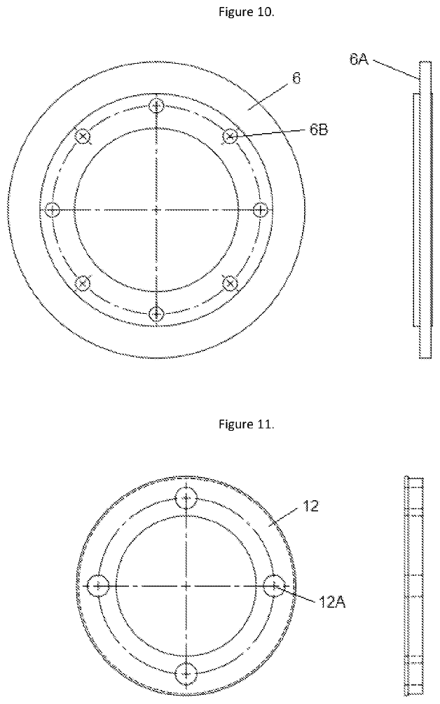

FIG. 3 shows the second assembly step. Second ring gear (9) with gear teeth (9A) is mounted on top of the first ring gear (5). The second ring gear is smaller to make space for the big needle bearing (45). When all the outer parts are bolted together through the holes on most outer parts (49) the big axial needle bearing (45) will transfer thrust forces between all the parts that together form the housing (1, 5, 9, 16, 17, 22, 23) and the first sun gear (3, 6), which again transfers the thrust forces through needle bearings and the main shaft (2) to the valve nut (40). Without the big bearing (45) the actuator would need thrust bearings all the way through the actuator; including the big bearing (45) simplifies the construction of the valve, but this is optional. Inside the second ring gear (9) are the second planetary gears (8) with needle bearings (8A) and shafts (8B). The shafts are pressed into the holes of the first sun gear (6). These holes (6B) are shown in FIG. 10 which illustrates the top half of the first sun gear (6). Also note the path (6A) for the big axial needle bearing (45). The second sun gear (7) is joined to bottom sun gear (10) of the split annulus gear. The modulo of the second planetary gear system is 1.0 in presented figures. The modulo is not fixed and can be changed to a value suitable for design parameters according to a specific design. One or more planetary gear systems similar to the second planetary gear system can be added on top of second planetary gear system if desired.

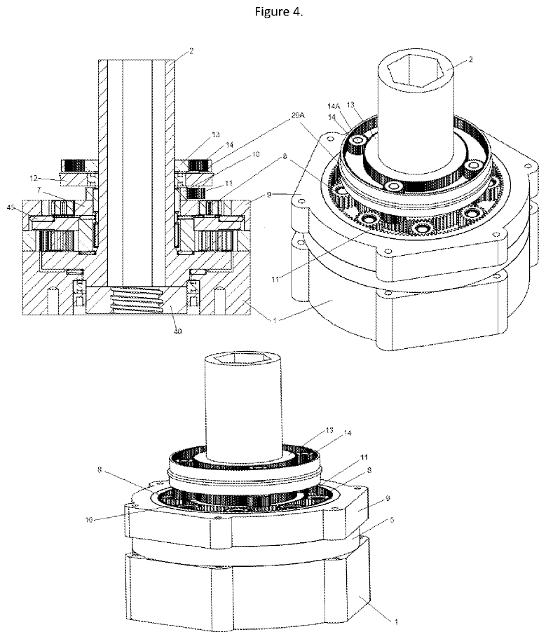

FIG. 4 shows the third assembly step. Here a split annulus gear system is added. The reason for including a split annulus gear system is to achieve higher gearing ratio as compared to the normal planetary gear system in this stage. This is relevant because the sun gear in each step must have a diameter larger than the diameter of the main shaft. E.g. in the presented figures, number of teeth in first planetary sun gear (3) is 64 while number of teeth in first planetary ring gear (5) is 104. This gives a gearing ratio of only 2.625. A three-stage planetary gear system will therefore only have a gearing ratio of about 18. In a split annulus gear system, the gearing ratio can be much larger. However, the split annulus gear's ability to transfer torque is less than that of a planetary gear system. Including a split annulus gear system to couple to the main shaft (2) through one or more planetary gear systems is therefore associated with certain advantages but is an optional addition.

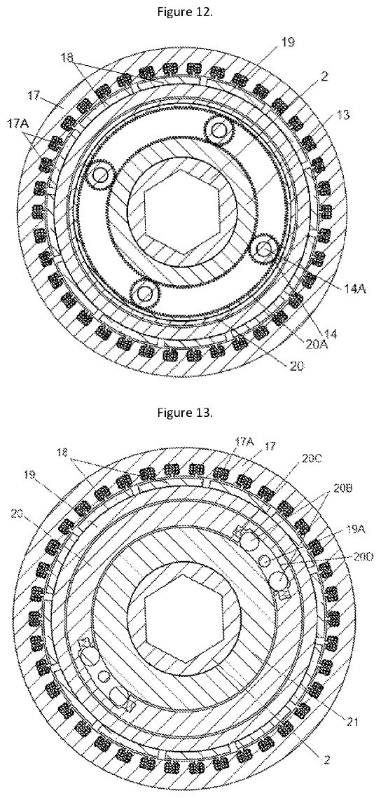

The split annulus gear system in FIG. 4 consists of modulo 0.5 gears. The modulo is not fixed and can be changed to a value suitable for design parameters according to a specific design. In the presented figures, the bottom annular sun gear (10) is the output and has 160 teeth, variations of number of teeth are possible for different applications. The bottom annulus planetary gears (11) in one example have 36 teeth. The top annulus planetary gears (14) in this example have 32 teeth, although obviously different numbers of teeth for one or both gears can be selected depending on the desired operation. The bottom annulus planetary gears (11) and the top annulus planetary gears (14) are mounted on the same shafts (14A). There are press passes between the hole in the planetary gears (11, 14) and the shafts (14A), so that the planetary gears (11, 14) and the shafts (14A) rotate as one part. The shafts (14A) are mounted into holes with needle bearings (12A) in the annulus gear carrier (12). The annulus gear carrier (12) is shown in FIG. 11. The annulus gear top sun gear (13) has 164 teeth in this example, although variations of number of teeth are possible for different applications. It is mounted with press pass against the main shaft (2) so the annulus gear top sun gear (13) moves with the main shaft (2). The annulus gear top ring (20A) is part of the bottom self-lock (20) mechanism. It has 228 teeth in this example, although variations of number of teeth are possible for different applications. The annulus gear top ring (20A) is the input to the annulus gear. The gearing ratio in the annulus gear with the presented setup is about 9.3, variations of gearing ratio are possible for different applications. Because the top sun gear has more teeth than the bottom sun gear rotation direction is reversed in the annulus gear. This is desirable because rotating the emergency handle (29) will then cause the main shaft (2) to rotate in the same direction. It also gives slightly higher overall gearing ratio. The calculation of gearing ratio is not straight forward, because the top annular sun gear moves with the main shaft (2) and the gearing ratio is therefore influenced by the rotational speed of the main shaft (2). FIG. 12 show a cross-section through the annulus top sun gear (13).

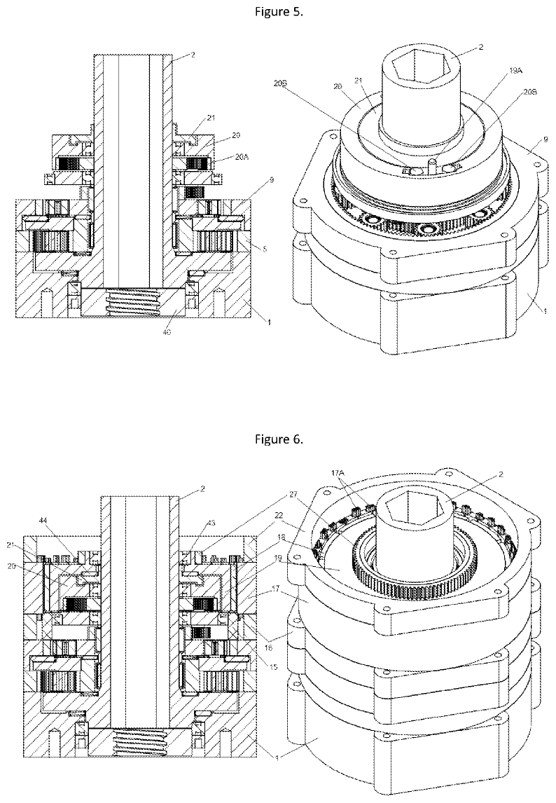

FIG. 5 shows the fourth assembly step. In this step the self-lock mechanism is assembled. The purpose of the self-lock mechanism is to ensure that torque only can be transferred from the motor to the valve. The self-lock mechanism blocks torque transfer from the valve to the motor and that way ensures that the valve will not move unintentionally. Novel in this actuator is that the self-lock locks against the main shaft (2) instead of against the housing (1, 5, 9, 16, 17, 22, 23). The reason for this design is that the self-lock mechanism can be positioned inside of the motor, which is efficient and provides a compact, space saving design. The self-lock mechanism in one example consists of a bottom self-lock (20), one or more rollers (20B), one or more unlock pins (19A), and the lock ring (21). The lock ring (21) has a press pass against the main shaft (2), so that they rotate together. The rollers (20B) will be pressed into locking position by the springs (20C) shown in the cross-section in FIG. 13. The locking action is provided by the surface (20D) which is machined so that the rollers (20B) is pressed both against the self-lock bottom (20) and the lock ring (21) when the rollers (20B) are moved closer to the unlock pins (19A) by the springs (20C). When a rotor frame (19) rotates, one of the unlock pins (19A) presses the one roller out of lock position. This allows rotation in the direction of rotor frame (19) rotation. The two unlock pins fit with press pass into two holes in rotor frame (19). Including two unlock pins and two rollers means that the locking mechanism can work with the rotor frame (19) rotating in either direction.

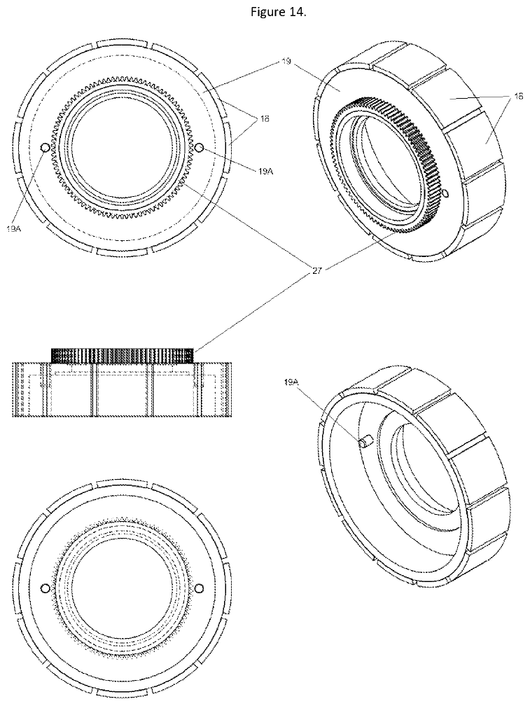

FIG. 6 shows the fifth assembly step. In this step the rotor comprising the rotor frame (19), magnets (18), an optional gearwheel for emergency operation (27) and unlock pins (19A) is put on top of the self-locking mechanism. In FIG. 6 most of the rotor is hidden, so the rotor is also presented in FIG. 14. The rotor rotates around the main shaft (2) and is supported by a ball bearing (43) and an axial thrust needle bearing (44) that rolls on top of the lock ring (21). The stator comprising laminated iron (17), coil support (16, 22) and coils (17A) is placed outside the rotor. An annulus gear carrier support (15) provides extra support for the annulus gear carrier (12) through a large radius bearing (43). Annulus gear carrier support (15) also provides support for the stator and ensures that the stator is centred around the main shaft (2). The axial centreline of the stator and the axis of rotation of the rotary frame (19) are coincident with the axial centreline of the main shaft. Again, this provides an extremely compact overall device. The electric motor can be a 3 phased axial flux PM-motor with 12 poles and distributed factional windings. The actuator can however use any electric motor with the correct dimensions. The motor will preferably include a through-hole in the centre, so that the motor can be mounted around the main shaft. This rules out all “off the shelf” motors.

It is possible to add a second “emergency shaft” and place an “off the shelf” motor or another motor on top of this emergency shaft to power the actuator, however this solution would be a lot bulkier than the presented design. The motor mounted in this way could be an electric motor, hydraulic motor or pneumatic motor. Magnets (18), coils (17A), laminated steel (17) etc. would then potentially not be required. Such an embodiment would include the rotary frame (19), but this would be rotated via the emergency shaft rather than forming part of the rotor of the motor itself. The emergency shaft can be included even if the rotary frame (19) forms part of the motor, to be used in emergency situations where for some reason the primary motor is not functioning.

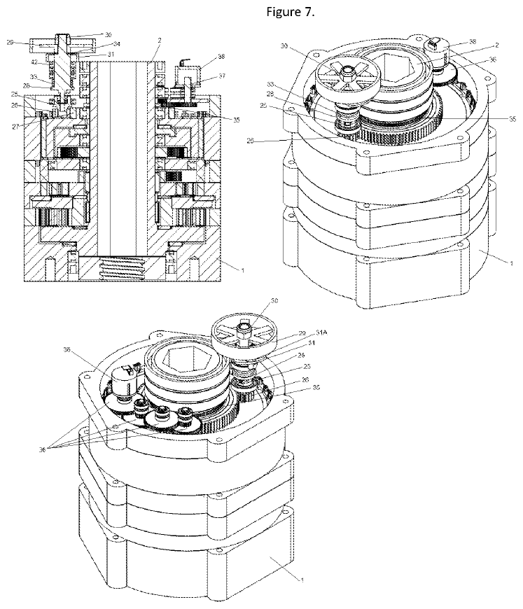

FIG. 7 shows the position of the emergency shaft and an optional encoder gearing. This figure is not an assembly step because lots of components are not shown in their final assembled positions. It shows the position of parts that would otherwise be hidden by the encoder plate (24). In FIG. 7 the encoder gearwheel (35) is installed on the main shaft (2). This encoder gearwheel interacts with the encoder gearing (36) and rotates the encoder shaft (37) inside the absolute encoder (38). The encoder gearing (36) is arranged so that the encoder shaft makes 1 rotation while the main shaft does about 30 rotations. This way the absolute encoder (38) can keep track of the number of rotations of the main shaft (2) and thereby also the position of the valve. It is assumed that the full stroke length of the valve is less than 30 turns, so that the absolute encoder (38) stays within 1 turn, however these parameters can be adjusted. The encoder gearing can, for example be rearranged if the actuator is mounted on a valve where the stroke length equals more than 30 turns.

FIG. 7 also shows the shafts and handle for emergency operation of the valve. The bottom emergency shaft (25) has a gearwheel (26) that interacts with gearwheel (27) on top of the motor. The bottom emergency shaft (25) will therefore rotate when the motor rotates the valve. It is undesirable that the top emergency shaft (28) and handle (29) rotate during normal operation, because emergency shaft seal (42) will be worn out fast. There is, therefore, a clutch between top emergency shaft (28) and bottom emergency shaft (25).

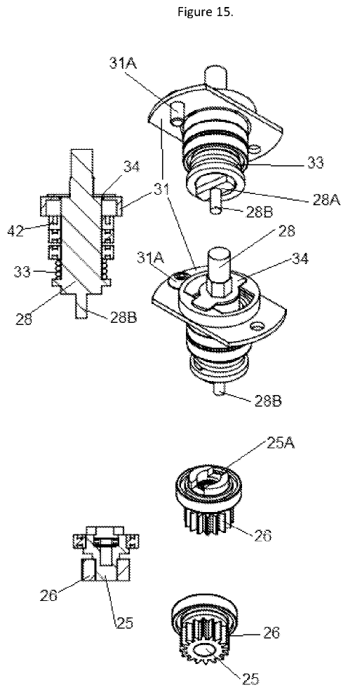

The function of the clutch is as follows. When the emergency operation is not used, a lock wing (34) stays on top of a lock (31). This way the lock wing (34) holds emergency shaft (28) lifted. If the emergency handle (29) is rotated the lock wing will rotate until it no longer rests on the lock (31). The spring (33) will then push top emergency shaft (28) down. The edge (28A) on the top emergency shaft (28) will then drop into the slot (25A) in the bottom emergency shaft (25) as top emergency shaft (28) rotates further. Rotating the emergency handle (29) will therefore rotate the rotary frame (19) and move the valve. The guide pin (28B) ensures that the top emergency shaft (28) drops straight. A nut (30) attaches the lock wing (34) and the emergency handle (29) to the top emergency shaft (28). The bolt (31A) fastens the lock (31) to the top lid (23). FIG. 15 shows the emergency shafts in more detail. The emergency handle (29) and the nut (30) are removed in FIG. 15 so that the lock wing is visible.

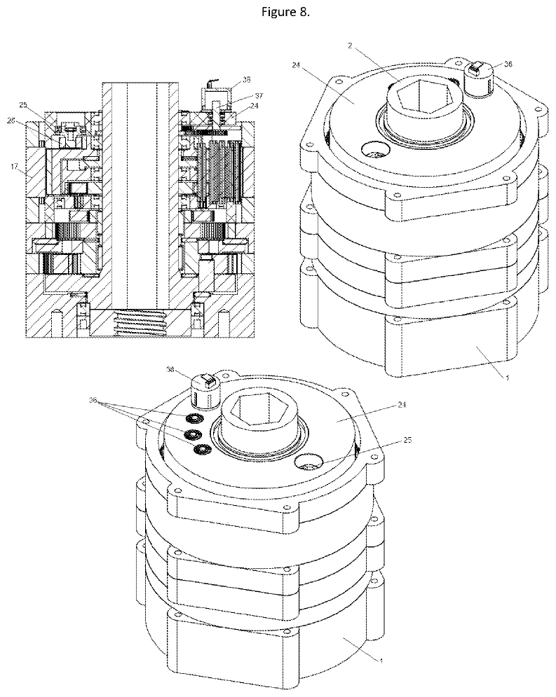

FIG. 8 shows the sixth assembly step. Here most of the components that are shown disassembled in FIG. 7 are mounted on the encoder plate (24) and the edge of the encoder plate (24) has been inserted by sliding into the stator. The bearing (43) between the encoder plate (24) and the main shaft (2) is not necessary, but it contributes by centring the laminated iron (17) in the stator around the rotor. The encoder plate (24) acts as support for the encoder (38), the encoder shaft (37), the encoder gearing (36) and the bottom emergency shaft (25).

FIG. 1 shows the seventh and last assembly step that completes the actuator. Here the top lid (23), with top seal (41), emergency shaft seal (42), top emergency shaft (28), top emergency shaft spring (33), emergency handle (29), nut (30), lock wing (34), lock (31) and bearings (43) are mounted on top of the actuator. Wires from the encoder and the motor can be taken out through the hole (23A) in the top lid (23). Other solutions for taking out the wires are also possible. It is necessary that the connection is IP68 if the actuator is to be submersible.

After the actuator is mounted on the valve it is possible to fill the hole in the centre shaft with grease and put a lid over the hole. This will ensure that the valve nut (40) is lubricated for a very long time.

1. Actuator for a gate or globe valve, comprising:
a main shaft (2), comprising an opening (51) extending along an axial centreline of, and through the main shaft (2) for receiving a valve stem of a gate valve or globe valve, and arranged for translating along the axial centreline,
a first planetary gear system (3, 4, 5, 6) including a plurality of planetary gears (4), a first sun gear (3, 6) and a first ring gear (5) wherein the planetary gear system is configured to rotate the main shaft (2) about its axial centreline, and
a motor for rotating the first planetary gear system, where the motor comprises a rotor frame which is hollow and surrounds the main shaft which extends through the center of the rotor frame,
wherein the axial centreline of the main shaft (2), a central axis of the sun gear of the planetary gear system and the axis of rotation of the rotor frame are coincident.

2. Actuator for a gate or globe valve according to claim 1, comprising
a hollow valve nut (40) coupled to the main shaft (2) and comprising a through-hole having an axial centreline coincident with the axial centreline of the main shaft and through which the valve stem extends in use,
wherein an internal surface of the through-hole is shaped to interact with the valve stem causing its translation along the axial centreline of the main shaft (2) upon rotation of the main shaft.

3. Actuator for a gate or globe valve according to claim 2, wherein the valve nut (40) is configured to be removably connected to the main shaft (2).

4. Actuator for a gate or globe valve according to claim 2, wherein the valve nut (40) and the main shaft (2) are formed as one integral piece.

5. Actuator for a gate or globe valve according to claim 1, wherein the motor for rotating the first planetary gear system is an electric motor.

6. Actuator for a gate or globe valve according to claim 1, comprising:
a rotor frame (19) rotatable about the main shaft (2) axial centreline and coupled to the main shaft (2) via the first planetary gear system (3, 4, 5, 6).

7. Actuator for a gate or globe valve according to claim 6, wherein the rotor frame (19) is hollow and surrounds the main shaft (2).

8. Actuator for a gate or globe valve according to claim 1, comprising a locking mechanism including:
a locking element (20) transitionable between a locked position in which the locking element (20) presses against the main shaft (2) or against a lock ring (21) that is fixed on the main shaft (2) to prevent rotation of the main shaft (2) and an unlocked position in which the main shaft (2) can rotate relative to the locking element (20).

9. Actuator for a gate or globe valve according to claim 8, when dependent from any of claim 6 or 7, wherein the locking mechanism comprises at least one unlock-pin (19A) coupled to the rotor frame (19) to transition the locking element (20) from the locked to the unlocked position when the rotor frame (19) is rotating in either direction around the main shaft (2) axial centreline.

10. Actuator for a gate or globe valve according to claim 1, comprising a second planetary gear system (7, 8, 9) including a second plurality of planetary gears (8), a second sun gear (7) and a second ring gear (9) where the planetary gear system (7, 8, 9) is arranged to couple the first planetary gear system (3, 4, 5, 6) to the main shaft to rotate the main shaft (2) about its axial centreline.

11. Actuator for a gate or globe valve according to claim 1, comprising a first split annulus gear system (10, 11, 12, 13, 14) including a bottom annulus sun gear (10), a plurality of bottom annulus planetary gears (11), a plurality of top annulus planetary gears (14), an annulus gear carrier (12) and a top annulus sun gear (13), where the top annulus sun gear (13) is arranged to rotate with main shaft (2).

12. Actuator for a gate or globe valve according to claim 11, where the annulus gear system (10, 11, 12, 13, 14) is configured to reverse the direction of rotation of the main shaft (2), by the top annulus sun gear (13) having more teeth than the bottom annulus sun gear (10).

13. Actuator for a gate or globe valve according to claim 1, wherein the hollow valve nut (40) is configured with internal threads allowing a threaded valve stem to be translated freely upwards along the axial centreline of main shaft (2) upon rotation of main shaft (2).

14. Actuator for a gate or globe valve according to claim 1, wherein the through-hole of the hollow valve nut (40) has a non-circular cross-section allowing a valve stem with similar cross-section to be translated freely upwards along the centreline of main shaft (2) upon rotation of main shaft (2).

15. Actuator for a gate or globe valve according to claim 6, wherein the rotor frame (19) is the frame of the rotor of the electrical motor, and is configured to rotate about the axial centreline of the main shaft (2).

16. Actuator for a gate or globe valve according to claim 6, wherein the motor is configured to turn the main shaft (2) by transferring torque through a bottom emergency shaft (25) and through the rotor frame (19) to cause the main shaft (2) to rotate.
